(19) United States
(12) Patent Application Publication
(10) Pub. No.: US 2016/0101544 A1
(43) Pub. Date: Apr. 14, 2016

(54) METHOD FOR MANUFACTURING FOAM SHOE MATERIAL

(71) Applicant: POU CHEN CORPORATION, Changhua County (TW)

(72) Inventors: Hann-Neng DAY, Changhua County (TW); Sheng-Jung HSIAO, Changhua County (TW); Chih-Chun TSAO, Changhua County (TW); Wen-Chung LIANG, Hsinchu County (TW); Shihn-Juh LIOU, Hsinchu County (TW); Chih-Lang WU, Hsinchu County (TW)

(21) Appl. No.: 14/877,892

(22) Filed: Oct. 7, 2015

(30) Foreign Application Priority Data
Oct. 13, 2014 (TW) 103135383

(51) Int. Cl. B29C 44/02; C08J 9/00

(52) U.S. Cl. CPC B29C 44/02; C08J 9/00; C08J 2203/08; C08J 2375/04; B29K 2075/00

(57) ABSTRACT

A method for manufacturing a foam shoe material includes the following steps. (a) A plate prototype is formed, wherein the plate prototype is composed of thermoplastic polyurethane. (b) The plate prototype is foamed by a supercritical fluid to form a foam shoe material including a plurality of microporous structures and an average aperture of the microporous structures is smaller than 100 micrometers.

### RELATED APPLICATIONS

This application claims priority to Taiwan Application Serial Number 103135383, filed Oct. 13, 2014, which is herein incorporated by reference.

### BACKGROUND

1. Technical Field

The present disclosure relates to a method for manufacturing a shoe material. More particularly, the present disclosure relates to a method for manufacturing a foam shoe material.

2. Description of Related Art

In order to reach the vibration absorption effect, the traditional shoes mostly use rubber as materials of their soles. However, using hung amount of rubber will cause increasing the weight of the shoes dramatically. Therefore, the rubber soles are mainly applied for general shoes but not applied for sneakers that request for lightweight.

In order to satisfy the above requirement of the sneakers, Ethylene-vinyl acetate (EVA) has been wildly used in the market to foam as materials of the soles. Not only the vibration absorption effect, the soles made by foaming EVA will be much lighter and more comfortable. Therefore, not only for the sneakers, the soles made by EVA are also used a lot in casual shoes. However, chemicals, such as foaming agent, cross-linking agent, or chemicals with other effects will be added according to manufacturing needs in foaming process of EVA. The addition of these chemicals will affect the health of the worker and the evaporated chemicals will also increase the loading of the physical environment. Because the foamed EVA often has the abovementioned residues of the chemicals, more processes are necessary for removing the residues.

In order to reduce the impact of the physical environment and the residue of the chemicals, the technology of using a supercritical fluid for foaming thermoplastic polyurethane (TPU) has been proposed. However, several processes, such as size measuring or shape cutting, are still necessary after obtaining the TPU foam material for obtaining the product in accordance with the designed size and style.

### SUMMARY

According to one aspect of the present disclosure, a method for manufacturing a foam shoe material is provided and includes the following steps. (a) A plate prototype is formed, wherein the plate prototype is composed of thermoplastic polyurethane. (b) The plate prototype is foamed by a supercritical fluid to form the foam shoe material, wherein the foam shoe material includes a plurality of microporous structures and an average aperture of the microporous structures is smaller than 100 micrometers.

According to another aspect of the present disclosure, a method for manufacturing a foam shoe material is provided and includes the following steps. (a) A thermoplastic polyurethane grain is heated to form a liquid thermoplastic polyurethane. (b) The liquid thermoplastic polyurethane is infused into a shaping mold for forming the liquid thermoplastic polyurethane into a plate prototype. (c) The plate prototype is moved to a foaming mold. (d) A supercritical fluid is introduced into the foaming mold and mixed into the plate prototype. (e) The foaming mold is cooled and the supercritical fluid is introduced out to allow the plate prototype foaming to form the foam shoe material.

### BRIEF DESCRIPTION OF THE DRAWINGS

FIG. 1 is a flow chart of a method for manufacturing a foam shoe material according to one embodiment of the present disclosure;

FIG. 2A to FIG. 2C are schematic diagrams showing detailed manufacturing steps of the method of the embodiment in FIG. 1;

FIG. 3 is a flow chart of a method for manufacturing a foam shoe material according to another embodiment of the present disclosure; and

FIG. 4A to FIG. 4E are schematic diagrams showing detailed manufacturing steps of the method of the embodiment in FIG. 3.

### DETAILED DESCRIPTION

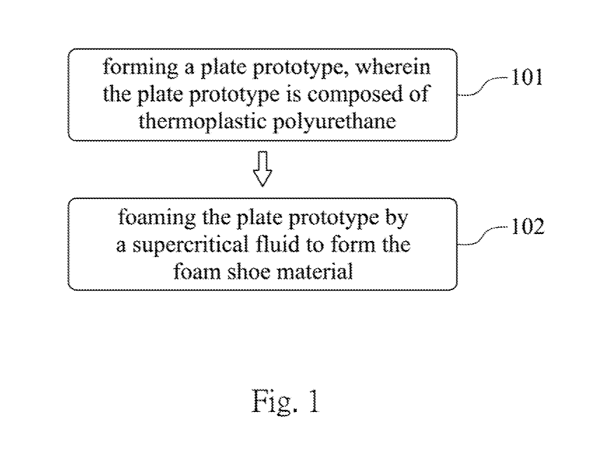

FIG. 1 is a flow chart of a method for manufacturing a foam shoe material according to one embodiment of the present disclosure. In FIG. 1, the method for manufacturing the foam shoe material is provided in the present disclosure and includes the following steps.

In step 101, a plate prototype is formed in which the plate prototype is composed of thermoplastic polyurethane.

In step 102, the plate prototype is foamed by a supercritical fluid to form the foam shoe material in which the foam shoe material has a plurality of microporous structures and an average aperture of the microporous structures is smaller than 100 micrometers.

As used herein, the term “supercritical fluid” is any substance at a temperature and pressure above its critical point, where distinct liquid and gas phases do not exist. Thus, it can be viewed as a uniform phase and the property of the supercritical fluid is between gas phase and liquid phase.

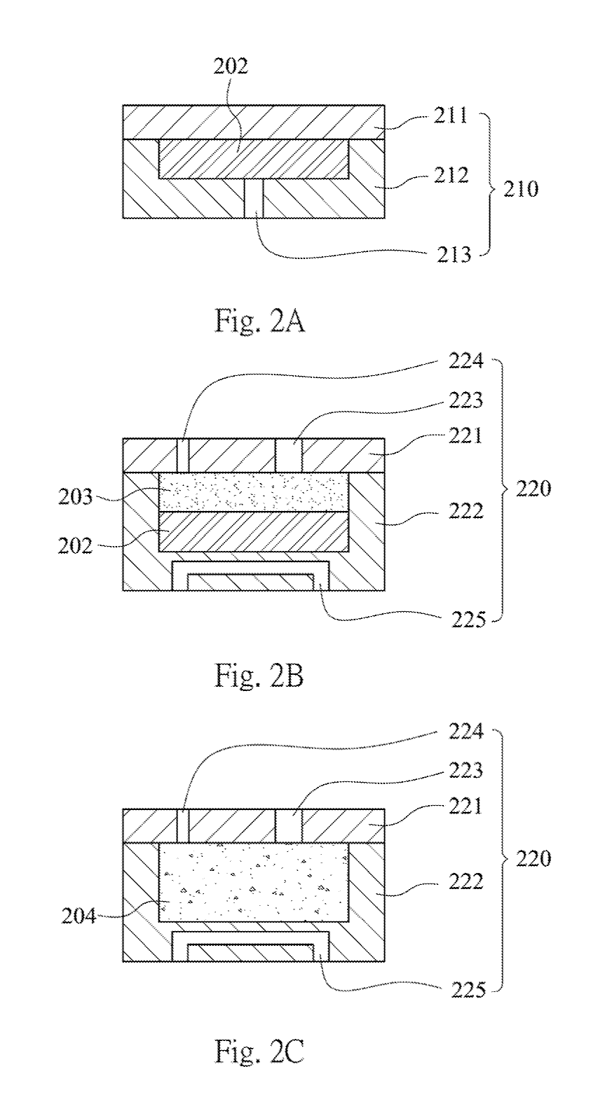

FIG. 2A, FIG. 2B and FIG. 2C are schematic diagrams showing detailed manufacturing steps of the method of the embodiment in FIG. 1. First, a shaping mold 210 is utilized to form a plate prototype 202 as shown in FIG. 2A. The shaping mold 210 includes a shaping upper cover 211, a shaping body 212 and an infusion channel 213. A liquid thermoplastic polyurethane is heated to 190° C. and then infused into the shaping mold 210 through the infusion channel 213. Then, the liquid thermoplastic polyurethane is cooled to room temperature, so that the plate prototype 202 is formed.

As shown in FIG. 2B, the plate prototype 202 is placed into a foaming mold 220 and a supercritical ethanol 203 is introduced therein. The foaming mold 220 includes a foaming upper cover 221, a foaming body 222, a gas inlet channel 223, a pressure releasing channel 224 and a cooling channel 225. In the process of FIG. 2B, the temperature of the foaming mold 220 is maintained at 250° C. and the pressure in the foaming mold 220 is maintained at 1000 psi for 15 minutes to mix the supercritical ethanol 203 into the plate prototype 202.

Finally, as shown in FIG. 2C, a cooling liquid is introduced into the cooling channel 225 to lower the temperature of the foaming mold 220 and the pressure releasing channel 224 is opened to release the pressure in the foaming mold 220. Because the decrease of the temperature and pressure, the supercritical ethanol 203 transforms into gaseous ethanol. Thus, the supercritical ethanol 203 mixed in the plate prototype 202 will expand and volatilize so as to foam and expand the plate prototype 202 to form a foam shoe material 204. The foam shoe material 204 includes a plurality of microporous structures due to the expansion and volatilization of the supercritical ethanol 203, and the average aperture of the abovementioned microporous aperture is smaller than 100 micrometers.

The abovementioned embodiment achieves the foaming efficacy by utilizing the changes of the temperature and pressure to transform the physical state of ethanol without adding chemicals. Thus, it is unnecessary to worry whether the chemicals remains on the foam shoe material 204 or not. The volatilized ethanol of the foaming process can be further recycled by the pressure releasing channel 224 for use and the environmental pollution can be further avoided. In addition, a specific gravity of the foam shoe material 204 manufactured according to the present embodiment is smaller than 0.5 and a rebound resilience of that is larger than 50%.

As used herein, the term “rebound resilience” means a ratio between a restoration amount after the material is compressed and a compression amount of the material. The abovementioned restoration amount and the compression amount can be volume, length or bending angle.

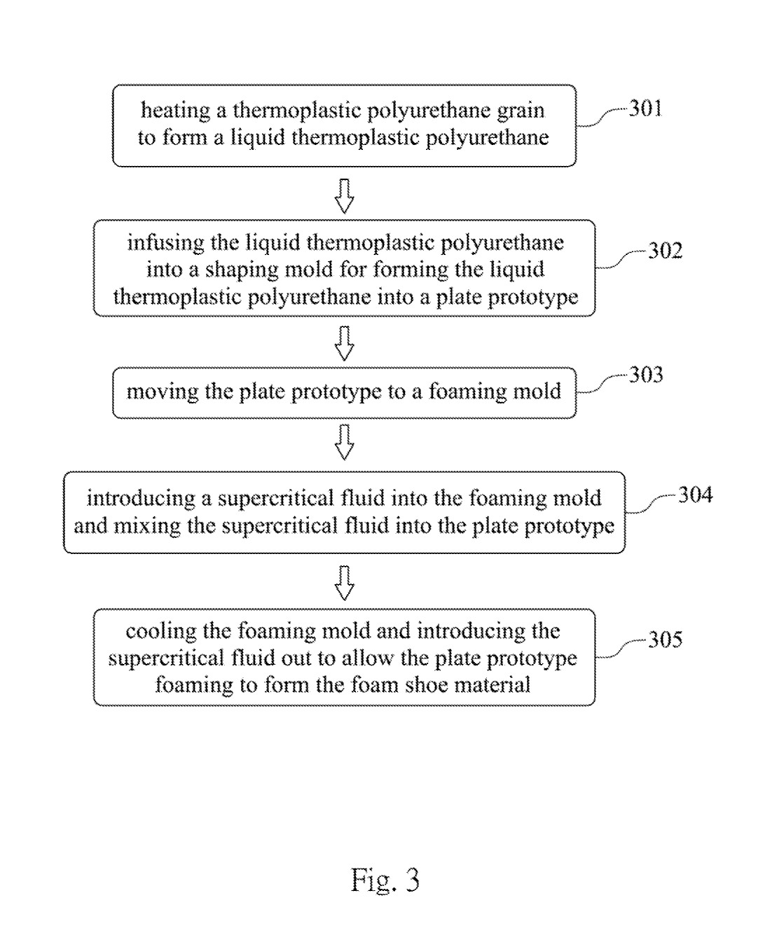

FIG. 3 is a flow chart of a method for manufacturing a foam shoe material according to another embodiment of the present disclosure. In FIG. 3, the method for manufacturing the foam shoe material is provided in the present disclosure and includes the following steps.

In step 301, a thermoplastic polyurethane grain is heated to form a liquid thermoplastic polyurethane.

In step 302, the liquid thermoplastic polyurethane is infused into a shaping mold for forming the liquid thermoplastic poly ethane into a plate prototype.

In step 303, the plate prototype is moved to a foaming mold.

In step 304, a supercritical fluid is introduced into the foaming mold and mixed into the plate prototype.

In step 305, the foaming mold is cooled and the supercritical fluid is released to allow the plate prototype foaming to form the foam shoe material.

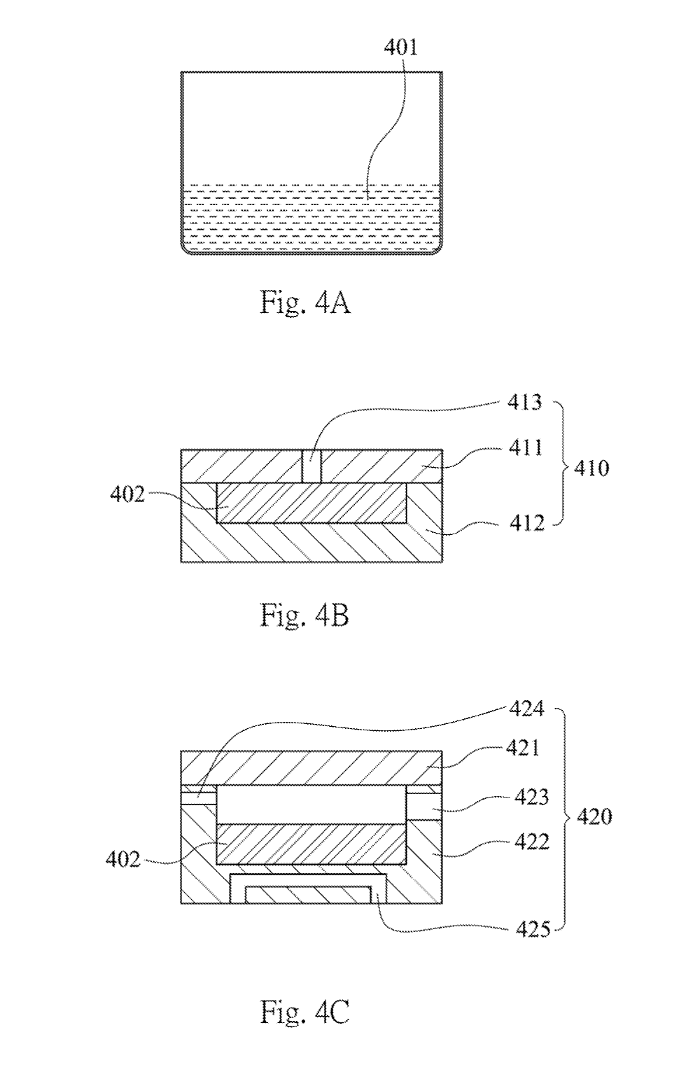

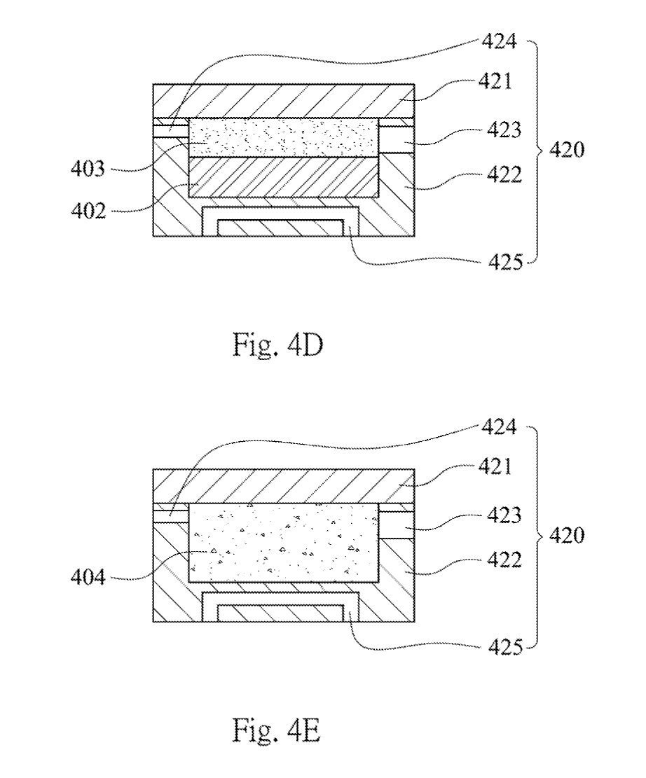

Detailed manufacturing processes are referred to FIG. 4A to FIG. 4E. FIG. 4A, FIG. 4B, FIG. 4C, FIG. 4D and FIG. 4E are schematic diagrams showing detailed manufacturing steps of the method of the embodiment in FIG. 3. In the manufacturing process, a shaping mold 410 and a foaming mold 420 are utilized. The shaping mold 410 includes a shaping upper cover 411, a shaping body 412 and an infusion channel 413. The foaming mold 420 includes a foaming upper cover 421, a foaming body 422, a gas inlet channel 423 and a pressure releasing channel 424.

First, thermoplastic polyurethane grains are heated to 230° C. to form liquid thermoplastic polyurethane 401 as shown in FIG. 4A.

As shown in FIG. 4B, the liquid thermoplastic polyurethane 401 is then infused into the shaping mold 410 by utilizing the infusion channel 413. After the liquid thermoplastic polyurethane 401 is cooled, a plate prototype 402 is formed. The plate prototype 402 is corresponding to the shaping mold 410.

And then, the plate prototype 402 is moved into the foaming mold 420 as shown in FIG. 4C. At this time, the foaming mold 420 can be preheated at first and the temperature of the foaming mold 420 is maintained between 100° C. and 160° C.

As shown in FIG. 4D, a supercritical carbon dioxide 403 is then introduced into the foaming mold 420. A pressure of the supercritical carbon dioxide 403 in the foaming mold 420 is maintained between 1000 psi and 3000 psi, and a temperature of the foaming mold 420 is maintained between 100° C. and 160° C. for 15 to 60 minutes to evenly mix the supercritical carbon dioxide 403 into the plate prototype 402.

Finally, as shown in FIG. 4E, the cooling liquid is introduced into a cooling channel 425 to lower the temperature of the foaming mold 420 and the pressure releasing channel 424 is opened to release the pressure of the supercritical carbon dioxide 403 in the foaming mold 420. Because the decrease of the temperature and pressure, the supercritical carbon dioxide 403 mixed into the plate prototype 402 transforms into gaseous carbon dioxide. Thus, the plate prototype 402 is foamed and expanded so as to form a foam shoe material 404. A plurality of microporous structures are remained in the foam shoe material 404 due to the expansion and volatilization of the supercritical carbon dioxide 403.

According to the abovementioned embodiment, a plurality of examples are provided, wherein the properties of the foam shoe material 404 can be adjusted by changing manufacturing parameters. The manufacturing parameters of each example are listed in Table 1 as follows.

TABLE 1
The manufacturing parameters of each example

| | | Pressure of | Temperature | |
|---|---|---|---|---|
| | Type of | supercritical | of foaming | Manufacturing |
| | supercritical | fluid | mold | time |
| | fluid | (psi) | (° C.) | (Min) |
| Example 1 | Carbon | 1000 | 100 | 60 |
| | dioxide | | | |
| Example 2 | Carbon | 2000 | 160 | 40 |
| | dioxide | | | |
| Example 3 | Carbon | 3000 | 120 | 15 |
| | dioxide | | | |

The properties of the foam shoe material of each example are listed in Table 2 as follows, in which a method for testing the rebound resilience is performed according to ASTM D-2632. A method for testing the specific gravity is performed according to ASTM D-297. The abovementioned ASTM D-2632, ASTM D-297 and ASTM D-2240 are standard test methods for materials made by ASTM International.

TABLE 2
The properties of the foam shoe material

| | | Average | Rebound | |
|---|---|---|---|---|
| | Specific | aperture | resilience | Expansion |
| | gravity | (μm) | (%) | Ratio |
| Example 1 | 0.29 | 50 | 65 | 1.5 |
| Example 2 | 0.26 | 60 | 57 | 1.6 |
| Example 3 | 0.22 | 80 | 52 | 1.6 |

In the above examples, the average aperture of the microporous structures in the foam shoe material 404 is smaller than 100 micrometers. The specific gravity of the foaming shoe material 404 is smaller than 0.5, and the rebound resilience of the foam shoe material 404 is larger than 50%. In addition, it further utilizes the shaping mold 410 to confirm the, size and style of the foam shoe material 404 and utilizes the foaming mold 420 to confirm the stereo structure of the foam shoe material 404. Thus, there is no additional process for foam shoe material 404 so that the manufacturing time can be saved and the waste produced in the cutting process can be reduced.

To sum up, the method for manufacturing the foam shoe material of the present disclosure has the following advantages. 1. It is unnecessary to perform additional processes, such as cutting, for the foamed thermoplastic polyurethane so that the manufacturing time of the foam shoe material and the waste of the materials can be saved. 2. The foaming efficacy can be achieved by utilizing the physical properties of the supercritical fluid so that it is unnecessary to add chemicals for avoiding the residue of the chemicals; and 3. The supercritical fluid used in the foaming process can be recycled for use so as to reduce the loading of the physical environment.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for manufacturing a foam shoe material, comprising:
(a) forming a plate prototype, wherein the plate prototype is composed of thermoplastic polyurethane; and
(b) foaming the plate prototype by a supercritical fluid to form the foam shoe material;
wherein the foam shoe material comprises a plurality of microporous structures and an average aperture of the microporous structures is smaller than 100 micrometers.

2. The method of claim 1, wherein the plate prototype is formed in step (a) by an injection molding, an extrusion molding, a hot embossing molding or a mold casting.

3. The method of claim 1, wherein the plate prototype is foamed in the step (b) at a temperature ranged from 100° C. to 160° C.

4. The method of claim 1, wherein a pressure of the supercritical fluid in the step (b) is ranged from 1000 psi to 3000 psi and a temperature of the supercritical fluid is ranged from 100° C. to 160° C.

5. The method of claim 1, wherein the supercritical fluid is carbon dioxide, water, methane, ethane, ethylene, propylene, methanol, ethanol, acetone or nitrogen.

6. The method of claim 1, wherein a specific gravity of the foam shoe material is smaller than 0.5.

7. The method of claim 1, wherein a rebound resilience of the foam shoe material is larger than 50%.

8. A method for manufacturing a foam shoe material, comprising:
(a) heating thermoplastic polyurethane grain to form a liquid thermoplastic polyurethane;
(b) infusing the liquid thermoplastic polyurethane into a shaping mold for forming the liquid thermoplastic polyurethane into a plate prototype;
(c) moving the plate prototype to a foaming mold;
(d) introducing a supercritical fluid into the foaming mold and mixing the supercritical fluid into the plate prototype; and
(e) cooling the foaming mold and introducing the supercritical fluid out to allow the plate prototype foaming to form the foam shoe material.

9. The method of claim 8, wherein the plate prototype is corresponding to the shaping mold.

10. The method of claim 8, wherein the foam shoe material is corresponding to the foaming mold.

11. The method of claim 8, wherein a temperature of the foaming mold in the step (d) is ranged from 100° C. to 160° C.

12. The method of claim 8, wherein a pressure of the supercritical fluid in the step (d) is ranged from 1000 psi to 3000 psi and a temperature of the supercritical fluid is ranged from 100° C. to 160° C.

13. The method of claim 8, wherein the supercritical fluid of the step (d) is carbon dioxide, water, methane, ethane, ethylene, propylene, methanol, ethanol, acetone or nitrogen.

14. The method of claim 8, wherein a specific gravity of the foam shoe material is smaller than 0.5.

15. The method of claim 8, wherein a rebound resilience of the foam shoe material is larger than 50%.

16. The method of claim 8, wherein the foam shoe material comprises a plurality of microporous structures and an average aperture of the microporous structures is smaller than 100 micrometers.
